(19) United States
(12) Patent Application Publication
(10) Pub. No.: US 2002/0119884 A1
(43) Pub. Date: Aug. 29, 2002

(54) Phosphate sealing frits with improved H2O durability

(76) Inventors: Carol L. Buhrmaster, Corning, NY (US); Robert Morena, Caton, NY (US); Kamjula P. Reddy, Corning, NY (US); Randall E. Youngman, Horseheads, NY (US)

Correspondence Address: Vincent T. Kung, Corning Incorporated, SP-TI-03, Corning, NY, 14831, US

(21) Appl. No.: 09/747,045

(22) Filed: Dec. 21, 2000

(51) Int. Cl. C03C 3/066; C03C 3/145; C03C 3/17; C03C 3/19; C03C 8/04; C03C 8/08; C03C 8/14

(52) U.S. Cl. 501/15; 501/17; 501/24; 501/26; 501/47; 501/48; 501/79

(57) ABSTRACT

Glass frit compositions, calculated in mole percent on an oxide basis, consisting essentially of 24.5 to 29.0% P₂O₅; 1.0 to 5.0% B₂O₃; 1.0 to 2.0% Al₂O₃; and sufficient amounts of SnO and ZnO (51.5 to 66.5% SnO, and 5.0-12.0% ZnO), wherein the molar ratio of SnO:ZnO is in the range of about 5.0:1 to 12: 1, and 0.0 to 2.0% SiO₂. The glass compositions exhibit, under NMR spectroscopic analysis of ¹¹B nuclei, a signal containing at least two peaks at a chemical shift in the range of approximately −18 to −25 ppm. The frit compositions exhibit long term stability, durability, and resistance to attack against moisture in high temperature and humidity conditions and are capable of attaching optical fiber Bragg gratings without the use of a hermetic chamber and the like. An optoelectronic device that employs a sealing material that comprises a frit made from the glass compositions.

### TECHNICAL FIELD OF INVENTION

The present invention relates generally to lead-free borophosphate glass compositions, and more particularly, to lead-free Al₂O₂ and B₂O₃ containing sub-pyrophosphate SnO—ZnO—P₂O₅ (SZP) sealing frit compositions suitable for bonding glass, glass-ceramic and ceramic materials, particularly bonding optical waveguide fiber and fiber Bragg gratings to substrates.

### BACKGROUND OF THE INVENTION

Bonding frits based on SnO—ZnO—P₂O₅ (SZP) sealing glasses are currently used for attaching optical waveguide fibers to negative expansion β-eucryptite glass-ceramic substrates to make athermal refractive index gratings or otherwise called “fiber Bragg gratings” or simply “gratings.” Fiber Bragg gratings are well known, and are widely used in the area of optical fiber communication systems and the like. Bonding a fiber Bragg grating to a temperature compensating substrate, such as β-eucryptite forms an athermal fiber Bragg grating.

The unique feature of SZP based frits is their moderate degree of bonding to the silica fiber. These frits typically possess the advantage of forming only a relatively weak to modest bond with the optical fiber. A laser is used in attaching fibers to the β-eucryptite substrate. From below the substrate, the laser heats a small amount of SZP-frit to the point of softening and a fiber is inserted. Heat is transferred up through the substrate. Pull-strength testing of laser sealed gratings bonded with the current standard SZP frits typically show strength values of 2.0-2.5 lbs. over a relatively wide range of laser output. Failure in pull-strength testing for gratings bonded with these SZP frits typically occurs by fiber pull-out, indicative of weak interaction between fiber and frit. As a result, during laser attachment, the fiber is not damaged or broken from the intense mismatch strains created by the typically large difference in coefficient of thermal expansion between the optical fiber (CTE≈0×10⁻⁷/°C.), and temperature compensation substrate (CTE≈−70×10⁻⁷/°C.). Other glass frit systems that have been investigated, such as PbO—ZnO—B₂O₃, PbO—B₂O₃, or mixed alkali-ZnO—P₂O₅ (RZP), all tend to result in fiber breakage after attachment.

Once a fiber Bragg grating has been bonded to a temperature compensating substrate, the fiber Bragg grating must be packaged with moisture getters in a hermetically sealed enclosure. The reason for doing this is primarily to protect the sealing frit from exposure to high moisture, high humidity and high temperature environments, which can affect the fiber-frit bond and lead ultimately to failure of the fiber Bragg grating by causing a center wavelength shift over the life of the grating. Historically, phosphate glasses are prone to degradation in aqueous environment. Although the currently used sealing glass frits have markedly better durability than other phosphate frits of higher P₂O₅ content, they still have relatively poor durability to high moisture and heat. The process of hermetically sealing fiber Bragg gratings, however, adds significantly to the cost, complexity and duration of the process of manufacturing a fiber Bragg grating. Thus, if it were possible, by eliminating the need for hermeticity, we can achieve great financial savings, as well as a reduction in manufacturing and production time of the fiber Bragg grating.

With this in mind, researchers have striven to develop alternative compositions for relatively low phosphate sealing glasses in hopes of combining the features of good durability and attachment at a relatively low softening temperature. For example U.S. Pat. No. 5,246,890 (Aitken et al.) teaches compositions for non-lead sealing glasses containing 25-50 mole percent P₂O₅, and SnO and ZnO in amounts such that the mole ratio of SnO:ZnO is in the range of 1:1 to 5:1. Optionally, the glasses may contain up to 5 mole percent of SiO₂; up to 5 mole percent Al₂O₃ ; and up to 20 mole percent B₂O₃. These SZP glasses are particularly useful as sealing glass frits for joining component parts in cathode ray tubes. The sealing frit disclosed in Aitken et al. preferably contains 29-33 mole percent of P₂O₅. Furthermore, Aitken et al. teaches that incorporating smaller amounts of P₂O₅, that is less than 29 mole percent, results in a sealing glass that exhibits an erratic and non-reproducible flow behavior in sealing operations.

Another example, U.S. Pat. No. 5,516,733 (Morena) modifies the powdered SZP sealing glass frit disclosed in U.S. Pat. No. 5,246,890 (Aitken et al.) by adding an appreciable quantity of mill additives comprising alumina and optionally zircon. A phosphate crystal phase is thermally developed in a seal produced with this modified SZP sealing glass, resulting in a substantial change in the viscosity-temperature characteristics of the seal, such that the seal remains rigid when reheated as a bake-out step. The overall effect of the mill additives on the viscosity of a fusion seal finds particular application in uniting the faceplate and funnel members to form a cathode ray tube envelope.

While U.S. Pat. No. 5,281,560 (Francis et al.) teaches non-lead sealing glasses containing 25-50 mole percent P₂O₅, 30-70% SnO, 0-15% ZnO wherein the mole ratio of Sn:ZnO being greater than 5:1; Al₂O₃ and B₂O₃, and an effective amount up to about 25% total of at least one oxide in the indicated proportions selected from the group consisting of Li₂O, Na₂O, K₂O, B₂O₃, Al₂O₃, SiO₂ and WO₃. These glasses are particularly useful as sealing glass frits in sealing material to join component parts in electrical and electronic devices. Unlike the present invention, however, the sealing frits disclosed in Francis et al.—like the sealing frit disclosed in Aitken et al.—preferably contain 29-33 mole percent P₂O₅. Moreover, again like in Aitken et al., Francis et al. specifically teach that lower amounts of P₂O₅ (less than 29 mole percent) will result in a sealing glass exhibiting an erratic and non-reproducible flow behavior in sealing operations. In their more preferred embodiment, Francis et al. disclose that P₂O₅, should be at or near the pyrophosphate stoichiometry, which is about 33%, as reflected in their examples.

Furthermore, persons versed in the art can recognize that a sealing frit, having the desired properties, can not be made from the compositions disclosed by Francis et al. For a sealing frit to function as we have envisioned, any significant amounts of alkali will induce crystallization by acting as an oxidizing agent to the SnO present.

Hence, the search has been continuous for a sealing frit that has improved durability from exposure to high moisture, high humidity and high temperature environments. Therefore, a great need exists for frit compositions that exhibit long term stability, durability, and resistance to attack against moisture and high humidity conditions, and to which fiber gratings can be attached without the use of a hermetic chamber.

### SUMMARY OF THE INVENTION

As a consequence of the need for more durable glass compositions, a general aspect of this invention is directed to providing lead-free, Al₂O₂ and B₂O₃ sub-pyrophosphate SnO—ZnO—P₂O₅ (SZP) glass compositions suitable for use as sealing frits for bonding glass, glass-ceramic or ceramic substrates. More particularly, another, principal aspect of the present invention pertains to a glass composition suitable for bonding optical waveguide fiber to substrates. The “sub-pyrophosphate” category encompasses glass compositions that have approximately less than 32% or 33%, or preferably even less than 29.5% P₂O₅, on a molar basis. The glasses of the present invention are lead-free compositions, as calculated in mole percent on an oxide basis, containing 24.5 to 29.0 % P₂O₅, 1.0 to 5.0 % B₂O₅, 1.0 to 2.0 % Al₂O₃, with SnO and ZnO in amounts such that the molar ratio of SnO:ZnO is in the range from about 5.0:1 to 12:1, (approximately 51.5 to 66.5% SnO, 5.0 to 12.0% ZnO), and 0.0 to 2.0% SiO₂. Additionally, the sub-pyrophosphate glass compositions exhibit, under NMR spectroscopic analysis of ¹¹B nuclei, a signal containing at least two peaks at a chemical shift in the range of approximately −18 to −25 ppm relative to aqueous boric acid. The SZP base glasses resulting from these compositions show markedly increased aqueous durability. Gratings attached with sealing frits made from such base glasses have shown excellent long term stability in damp or humid, hot environments, and may not require hermetic packaging during their service life.

Additional features and advantages of the invention will be set forth in the detailed description that follows. It is to be understood that both the foregoing general discussion and the following detailed description and examples provided herein are merely exemplary of the invention, and are intended to provide an overview or framework for understanding the nature and character of the invention as it is claimed.

### BRIEF DESCRIPTION OF THE DRAWINGS

FIG. 1. A fiber Bragg grating device showing frit attachments.

FIG. 2. Aqueous durability of SZP frits as a function of B₂O₃ content of the composition.

FIG. 3. Comparative data of center wavelength stability in damp heat environment for gratings attached with two different SZP glass frit compositions.

FIG. 4. ¹¹B nuclei MAS NMR spectra, measured at 11.7 T, for a series of SZP glasses, exhibiting at least two signal-peaks in a chemical shift range of −18 to −25 ppm.

FIG. 5. ¹¹B nuclei MAS NMR spectra for five different glass compositions, shown in comparison and illustrating a signal-peak at a chemical shift of −20 ppm, indicating the presence of BPO₄. (Dashed-lines denote fits to experimental data.)

### DETAILED DESCRIPTION OF THE INVENTION

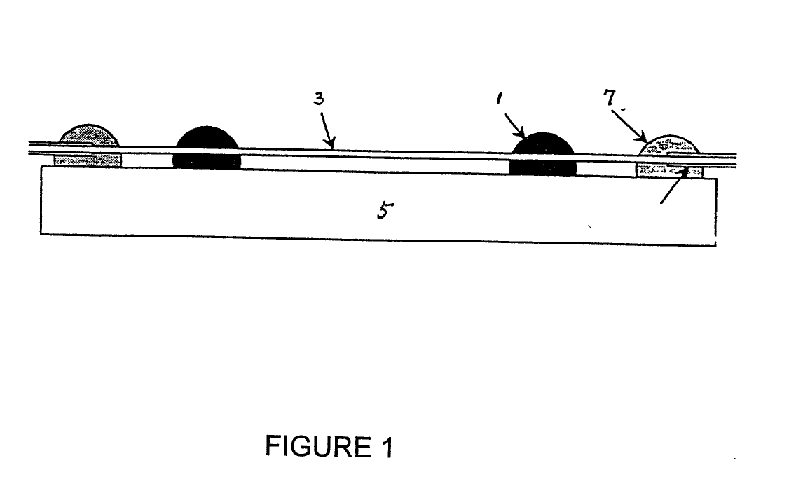

One method of athermalizing a fiber Bragg grating is to secure the grating to a temperature compensating substrate, as shown in FIG. 1. A tin-zinc-phosphate (SZP) glass frit 1 is used currently to attach a piece of partially stripped, optical fiber 3 to a β-eucryptite glass ceramic substrate 5 to achieve athermalization. A dollop of epoxy 7 is used to attach each end of the stripped fiber to the substrate. This grating is then packaged in a hermetically sealed enclosure, primarily to prevent a shift in center wavelength and to protect the frit from exposure to moisture, which can ultimately cause complete failure of the device. As currently practiced, the hermetic package, together with moister getters, add substantial manufacturing cost to this product. Thus, a significant cost and process advantage can be achieved if the need for hermeticity were eliminated.

In other words, the shortcoming of the current SZP frit blends is their low durability to water. Gratings made with these frits show unacceptably high shifts in center wavelength when subjected to damp-heat conditions (85° C., 85% relative humidity). The center wavelength shifts of non-hermetically packaged gratings made with standard frits exceed the permissible maximum for most grating applications of ±0.05 nm within 100-200 hours. A fiber Bragg grating must provide a stable center wavelength for optical stability. Since the device is designed to separate specific wavelengths, any significant deviation would affect optical performance.

To eliminate the need for a hermetic package and other problems, a better glass frit composition needs to be developed. Such a glass frit will need to be both durable in high temperature and humid environments and provide sufficient center wavelength control and thermal stability throughout the life of the grating without hermetically sealing the device. A successful frit composition must have a number of major attributes. The frit must be moisture resistant, as measured in relation to any shift or change to the center wavelength of the fiber Bragg grating after exposure to damp heat testing. The frit needs to provide good strength in the frit-fiber bond and good adaptation to photo-elastic stress or transient stress. These properties are related to possessing an adequate operating window for laser attachment, measured by melting characteristics such as appearance, pull strength, and damage to optical fiber, versus input voltage. These attributes can be counter indicated, thus developing a sealing frit for fiber Bragg gratings has often meant finding the optimum balance.

We undertook a study to understand the relationship between the composition of the frit and its durability. The results of the study can be summarized in reference to four main points. Namely, first, water durability of Sn—Zn—P glasses depends on the level of P₂O₅ and B₂O₃ in the glass. For compositions in a matrix experiment, good water durability could be obtained by either lowering P₂O₅ or increasing B₂O₃, or both. Second, the firing temperature range for optimal bond strengths between frit and fiber is generally smaller for durable frits as compared to the currently used production frit composition. Third, the firing temperature has a significant effect on the measured bond strengths. Boron appears to play a key role in the interfacial bond between the frit and fiber. Fourth, photoelastic measurements using asymmetric sandwich seals indicated that the composition of a filler can have significant effect on the magnitude of transient stresses in silica.

Environmental durability against moisture in phosphate glasses is a function of many variables, but correlates most immediately with the P₂O₅ level. The amount of P₂O₅ controls aqueous durability in phosphate glasses. Table 1 lists three compositions for glass frits that are illustrative of this principle. Table 1 also lists their relative durability to immersion in 90° C. de-ionized water, as measured by their change in weight (mg/cm²). Samples of the three compositions were immersed for 24, 48, 72 and 96 hours, with all measurements performed on the same test specimen of each composition, respectively. Comparative Example 1 is a SZP-sealing frit that had been used for laser attaching gratings. Experimental comparison shows that a decrease in the P₂O₅ level from 32 mole % (pyrophosphate) for Comparative Example 2, to 28.5 mole % (sub-pyrophosphate) for Comparative Example 1, is sufficient to improve aqueous durability by more than one order of magnitude. (Note that the aqueous durability on the Pb-based frit, Comparative Example 3, is intermediate between the two kinds of SZP frits. Although frits like Comparative Example 3, used traditionally for sealing cathode ray tubes (CRTs), have been considered to have excellent aqueous durability, the better durability of Comparative Example 1, compared to Comparative Example 3 indicates how much more demanding the durability requirements are for a frit used in grating attachment than for a CRT-sealing frit.) Even though, the composition of Comparative Example I (in mole percent, 28.5% P₂O₅; 1.0% B₂O₃; 63.6% SnO; 6.4% ZnO; and 0.5% Al₂O₃) places it in the “sub-pyrophosphate” category, this glass still exhibits unacceptable levels of aqueous durability in a non-hermetically sealed device.

To address the aqueous durability problem, we considered several possible compositional modifications of Comparative Example 1 to improve its durability. One way to improve aqueous durability was to lower the P₂O₅ content. Previously, only small reductions were possible, however, since reducing the P₂O₅ content any further below roughly 28.5% would jeopardize the glass stability in the SZP system. Our inventive compositions have managed to overcome this limitation. Our modifications in part have been able to reduce the P₂O₅ content to lower levels, to as much as 24.5 mole %—although for practical purposes to 25.0 or 25.5 mole % is more preferred—at which a glass could still form a stable frit, that is, a fine powder (20-40 μm) which exhibits viscous flow without premature crystallization.

To improve stability, small amounts of a second glass-forming oxide, B₂O₃, were added, substituting for SnO and ZnO. The addition of B₂O₃ to phosphate glasses creates BPO₄ groups for certain composition ranges of phosphate glasses. These groups act as strong three-dimensional anchors on the structure, as evidenced by increases in softening and annealing point, and decreases in thermal expansion. Although BPO₄ groups slightly increase the softening and annealing temperatures, the increase is minimal and within the tolerable range. In fact the increase is only 20° C., well within sealing temperature allowances. More importantly, as will be discussed later in greater detail, the presence of BPO₄ groups substantially increase the aqueous durability of our inventive glass compositions. The Al₂O₃ level was increased slightly, although not enough to cause precipitation of an aluminum phosphate compound (possibly AlPO₄). Small amounts of SiO₂ could be tolerated, but preferably this compound should be kept to a minimum. In fact, concerns about SiO₂ causing a large increase in the T_{g} in SZP glasses, lead us to give higher priority to B₂O₃ and Al₂O₃ substitutions in the composition study.

Additionally from our studies, it appears that the closer that one approaches a pyrophosphate composition with regard to P₂O₅ levels, the concentration of isolated, tetrahedral PO₄ decreases in the glass, in favor of connecting with other phosphate groups to form chains or cyclical structures. Consequentially, PO₄ groups become less available to form BPO₄. This phenomenon also suggests that there may be an upper limit to the level of P₂O₅ at which increasing levels of B₂O₃ will cease to work to increase durability and stability. This limit may be at approximately 29 mole % P₂O₅.

The glass frit compositions of the present invention comprise 24.5 to 29.0 % P₂O₅, 1.0 to 5.0 % B₂O₅, 1.0 to 2.0 % Al₂O₃, with SnO and ZnO in amounts such that the molar ratio of SnO:ZnO is in the range from about 5:1 to 10:1, (approximately 51.5 to 66.5 % SnO, 5.0 to 12.0 % ZnO), and 0.0 to 2.0 % SiO₂, as calculated in mole percent on an oxide basis. Preferred embodiments of the inventive glass compositions, as calculated in mole percent on an oxide basis, consist essentially of 25.0 to 28.5 % P₂O₅, 1.3 to 5.0% B₂O₃, 1.0 to 2.0%, Al₂O₃, 52.0 to 65.0% SnO, and 5-12% ZnO, wherein the molar ratio of SnO:ZnO is approximately 5.0:1 to 11.7:1, and 0.0-1.0% SiO₂. Other more preferred embodiments, in mole percent, can contain 25.5 to 28.3% P₂O₅, 1.3 to 3.0% B₂O₃, 1.0 to 2.0% Al₂O₃, while maintaining the amounts of SnO and ZnO such that the molar ratio of SnO:ZnO is approximately 5.0:1 to 10.5: 1, and 0.0-0.5% SiO₂. Alternatively, the compositions, in mole percent, can contain 26.5 to 28.0% P₂O₅, 2.0 to 3.0% B₂O₃, 1.0 to 2.0% Al₂O₃, while keeping the SnO:ZnO molar ratio within the range of about 5:1 to 10:1. The amount of P₂O₅ can also range from 25.0 to 26.5 mole %. These frit compositions have comparable coefficients of thermal expansion (CTE) as the SZP frits currently used in fiber Bragg gratings. Specifically, in the temperature range of 25-300° C., frits made with a filler exhibit a CTE of approximately −10×10⁻⁷/°C. The softening temperatures of the glasses range from about 345° C. to approximately 380° C., and are generally higher for glasses containing more B₂O₃.

### EXAMPLES

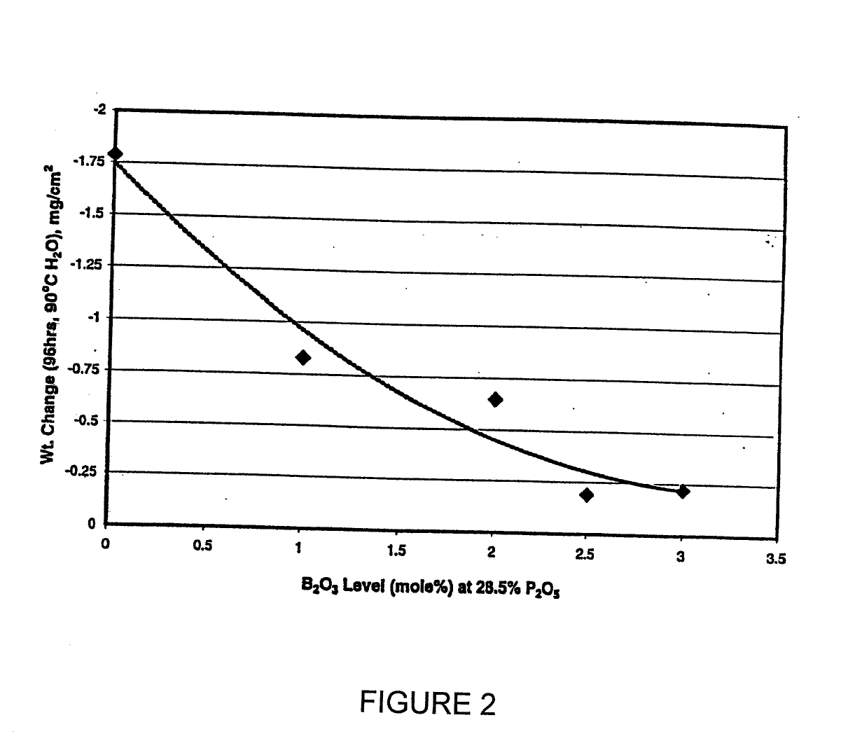

The invention will be further clarified by reference to specimens in the several accompanying Tables and are intended to be exemplary of the invention. Table 2 shows several compositions for a series of glasses and their respective chemical durability data. To a basic SZP-glass composition, Comparative Example 4, which contains 28.5% P₂O₅, B₂O₃ was added as a replacement for SnO+ZnO, with the SnO/ZnO ratio held at approximately 10:1 to 12:1. B₂O₃ levels of 2.0, 2.5 and 3.0 mole % were examined. As a general observation, for the glass examples, addition of even a small amount of B₂O₃ (1 mole %) can result in a lowering of the aqueous corrosion by half over long periods of exposure. In FIG. 2, the aqueous durability results for Comparative Examples 1 and 4, and Examples 1-3 are plotted as a function of the B₂O₃ content. Even though, all of these glasses contain approximately 28.5 mole % P₂O₅, one can observe a significant increase in durability with increasing B₂O₃ content. Durability improves in a continuous, exponential fashion with the addition of B₂O₃ to the basic phosphate glass composition. Significant improvement became noticeable at about 2 mole % B₂O₃.

As will be discussed, below, in greater detail when relating to Table 4, aqueous durability tests were performed on samples. Composition of Example 5 in Table 2, exhibits superior aqueous durability to the currently used sub-pyrophosphate (Comparative Example 1) or pyrophosphate SZP frits (Comparative Example 2), or even vitreous PbO—ZnO—B₂O₃ frits (Comparative Example 3) in Table 1. Hence, Example 5 is a preferred composition of the inventive frit. Example 5 is a glass that consists of both lowered P₂O₅ level (26.5 mole %) and increased B₂O₃ content (2.8 mole %). The data indicates that this glass exhibits better durability than the other glasses in the series having 28.5 mole % P₂O₅ listed. This indicates that both lower P₂O₅ levels, and higher B₂O₃ levels are required for best aqueous durability. Also studied was the effect of SiO₂ partially replacing B₂O₃, at levels of 0.5, 1.0, and 1.5 mole %. Unfortunately, durability decreased with increasing levels of SiO₂.

Table 3, provides a more extensive listing of illustrative glass compositions, which satisfy compositional ranges for our invention, along with a listing of more comparative examples. Similar to Examples 1-5 in Table 2, in each instance of the inventive compositional examples in Table 3, B₂O₃ was added by replacement of SnO and ZnO, with the SnO/ZnO ratio at approximately 5.0:1 to 10.0:1 in each respective glass. Again, aqueous durability improves with increasing B₂O₃ levels, although experiments suggest that the degree of improvement tends to level-off at B₂O₃ contents higher than 3.5 mole %.

Although a few of the comparative examples appear to have P₂O₅ levels that are within the compositional ranges that we have specified, these comparative examples exhibited less than satisfactory performance when subjected to aqueous durability testing over prolonged periods. A possible explanation for this difference may be that they do not contain sufficient levels of BPO₄, as referred to in the discussion above about PO₄ group levels and that will be discussed below in regard to NMR spectra. Alternatively, the particular comparative examples did not have the correct combination to form BPO₄ in sufficient quantities, because the composition may depends on other factors, such as SnO or ZnO levels being held constant. This fact illustrates that our inventive glass compositions would not be obvious, although not easily distinguishable by merely observing the composition ranges alone.

For instance, listed in the accompanying Table 7 are three different SZP-frits that have been evaluated as attachment frits for fiber Bragg gratings. The three frits are relatively close in composition, with P₂O₅ content ranging from 26.5 to 28.5%, and B₂O₃ level content varying from 1.0 to 2.8%. But, as seen from the Table, the frits differ widely with respect to water durability. Examples 5 and 20 are much more durable than Comparative Example 1.

TABLE 7

| Oxide (mole %) | Comp. Ex. 1 | Ex. 20 | Ex. 5 |
|---|---|---|---|
| P₂O₅ | 28.5 | 26.5 | 26.5 |
| B₂O₃ | 1.0 | 2.5 | 2.8 |
| ZnO | 6.4 | 6.3 | 5.6 |
| SnO | 63.6 | 63.2 | 63.7 |
| Al₂O₃ | 0.5 | 1.4 | 1.5 |
| Visual character of glass | clear | opal | opal |
| Softening point | 325° C. | 335° C. | 340° C. |
| Aqueous durability | poor | excellent | excellent |
| (90° C. de-ionized H₂O) | | | |

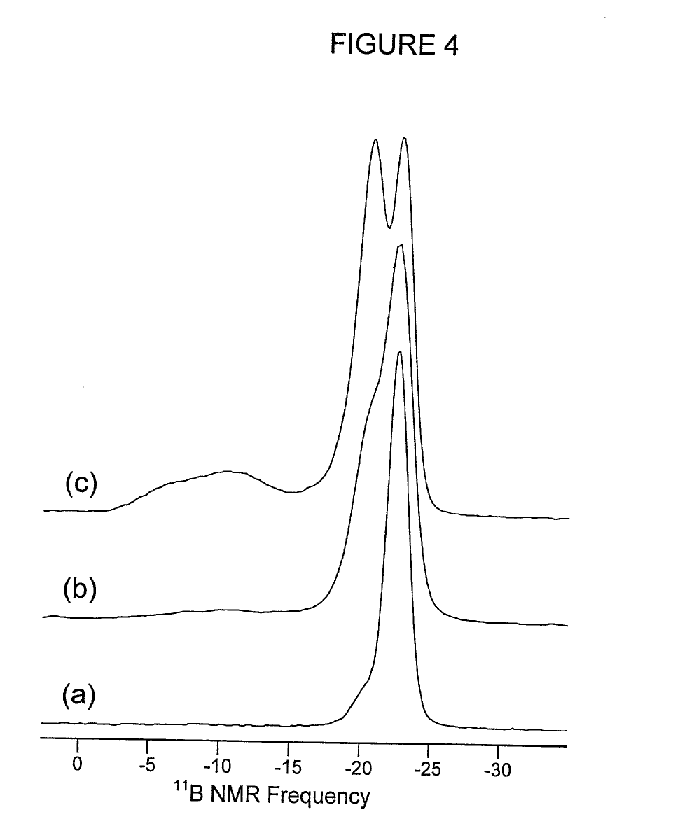

NMR data have served as an extremely powerful tool to interpret structural differences between the three seemingly similar frits that are responsible for the performance differences, shown above. Illustrated in accompanying FIG. 4, are solid state NMR data for the ¹¹B nucleus in each of the three glass: (a) Comparative Example 1, (b) Example 20, (c) Example 5. The NMR frequencies have been referenced to an external aqueous boric acid solution. The NMR spectra are characterized by showing one or two relatively sharp features in the chemical shift range of −15 to −30 ppm. This pattern may be ascribed, on the basis of published literature studies, to the presence of tetrahedral boron (i.e. BO₄) groups. Note that for (c), Example 5, this signal is split into two distinct peaks, with a resonance at approximately −20 ppm and one at approximately −23 ppm. The presence of two types of tetrahedral boron is especially significant. The −23 ppm peak corresponds to tetrahedral boron in B—O—B linkages in the glasses (i.e. BO₄ groups), while the −20 ppm signal corresponds to tetrahedral boron in B—O—P linkages (i.e. BPO₄ groups). As observed in Table 8, all of these three glasses contain some quantity of both types of tetrahedral boron, although the amount of BPO₄ groups varies with glass composition. The greater the amount of BPO₄ groups present in a SZP glass, we have observed, the better the aqueous durability the glass tends to exhibit.

TABLE 8

| | Trigonal Boron | BPO₄ groups | |
|---|---|---|---|
| GLASS | (−10) | (−20) | BO₄ groups (−23) |
| (c) Example 5 | 13% | 60% | 27% |
| (b) Example 20 | 7.2% | 39% | 53.8% |
| (a) Comp. Ex. 1 | 1% | 7.9% | 91.1% |

Note that there is also a second feature that appears in the NMR data for a couple of the glasses: a small peak centered at approximately −10 ppm. This peak corresponds to trigonal boron, i.e., BO₃ groups in the glass. Example 5 contains the highest fraction of three-coordinated boron of the three glasses. Comparative Example 1 contains virtually no BO₃ groups, while Example 20 is intermediate with respect to the concentration of BO₃ groups.

The NMR data does much to provide a structural rationale for the differences noted above in the behavior of the three seemingly similar glasses. Phosphorus complexed with boron, forming BPO₄ groups (Examples 5 and 20), results in a much more tightly bound assembly than P₂O₅. This makes the ordinarily easily-soluble phosphorus cation more difficult to remove, and hence the much better aqueous durability of Examples 5 and 20 compared to Comparative Example 1.

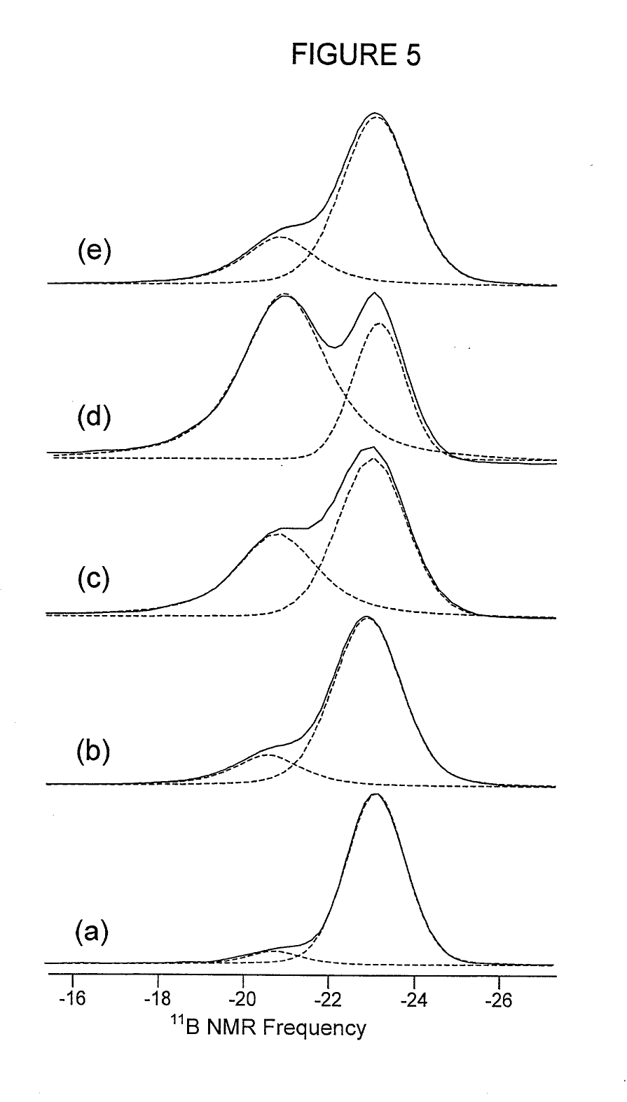

FIG. 5 shows in detail the NMR spectra of five different glass compositions: (a) Composition Example 1, (b) Example 18, (c) Example 20, (d) Example 5, (e) Example 19. The plot contains data for two series of glasses with two different P₂O₅ contents (28.5 mole %: (a), (b), (e), and 26.5 mole %: (c), (d)), where the fraction of BPO₄ is consistent within each series of P₂O₅ compositions. This figure shows only the tetrahedral boron peaks, with deconvolution of the BPO₄ and BO₄ units. The plot is in ascending order based on B₂O₃ content of the glasses, starting with (a) Composition 1, and ending with (e) Example 19. As one can see in FIG. 5, the plot of data for increasing B₂O₃ content does not necessarily match the increase in the −20 ppm peak intensity. It would be difficult to compare these five glasses simply on the B₂O₃ content.

Aqueous durability testing was performed on fired flow-buttons prepared from powders of each of the glasses listed in Tables 1, 2, and 4. The flow-buttons were initially hand-pressed cylinders (approximately 3.5 cm tall×1.25 cm diameter) made from powders with a mean particle size of 20-40 μm. The flow-buttons were fired at approximately 380-410° C. on platinum foil and then removed for the tests. The test consisted of immersing the specimens in the test solution, and then assessing durability on the basis of weight change (normalized to surface area), and appearance. The glass specimens for durability testing for this series were core-drilled (diameter≈16 mm and thickness≈2.8 mm) from annealed patties, and the two sides of the specimens were polished using cerium oxide. The glass specimens were placed in a plastic (nalgene) bottle containing 100 ml of de-ionized water. The bottles were placed in an oven set at 90° C. to heat to temperature. The weight of specimens were measured after 0, 1, 5, and 13 days by using a precision balance. The water was analyzed by ICP to determine the chemical elements that were leached from the glass.

Table 4 provides a list of the weight changes observed after different times in the 90° C. water. Note that the samples were returned to the original water after each measuring of the weight. In addition to weight change data, the softening temperatures (parallel plate viscosity measurement), relative light transmission through the glass, and ranking of the physical appearance of samples after the durability test are also given in Table 4. Arranged on a scale of 1 to 6, both the inventive examples and the comparative examples were ranked according to their performance, wherein the samples with the best durability were given a rank of 6, and the worst were given a rank of 1. The concentration of the elements leached into the water in parts per billion is given in Table 5.

From the water durability data, in Tables 4 and 5, we can observe several favorable properties of the inventive frit compositions. In Table 4, the best examples of the present invention ranked at least either a 5 or 6. All the compositions with 25.5 mole % P₂O₅ exhibited good durability in hot water irrespective of the levels of other elements. Using as a reference the durability data of currently available frit compositions, our inventive glasses with weight loss less than 2-3 mg/cm² (preferably less than 1 or 0.8 mg/cm²) after 13 days in 90° C. water can be considered to have improved durability. In clear glass samples, a white reaction layer was observed on the surface of the specimen. Immersed in 90° C. de-ionized water, specimens tend to form a white precipitate within 48 hours, and to produce a milky appearance to the supernatant. When the amount of P₂O₅ is greater than 25.5 mole %, the durability of the glass could be improved by increasing the levels of B₂O₃ and Al₂O₃. That is, excess P₂O₅, above 25.5%, can be counterbalanced by increased amounts of borate or alumina. In Table 5, elemental analysis of the immersion water indicates that all the elements present in the glass are being leached out in approximate proportion to their concentration levels in the glass. The weight change measurements and the appearance of the surface of glass specimens after the durability test, tend to agree.

Measurements of pH indicate that the dissolution of the glass in water makes the aqueous solution more acidic. Glasses with poor durability tend to dissolve much faster due to increasing acidity of the solution over time. For glass samples with good durability, the weight changes are less than 1.2 mg/cm². Because of the small weight changes, it becomes difficult to differentiate among these samples that have good durability. To establish the variability in durability test results, multiple samples from different melts were evaluated. Table 6 shows the weight change data for five different compositions.

As noted from Table 2, we observed an improvement in both bench durability tests with increasing B₂O₃ additions. Nonetheless, the performance of a fiber Bragg grating device we found to depend on the dimensional stability of the substrate durability of the SZP-frit in moist environments and the stability of interfacial bounds at fiber/frit/substrate interfaces. While it was observed that increasing the boron content does improve the durability of these glasses, the effect of other elements on glass durability is not well understood. Therefore, it was decided to conduct a statistically designed matrix experiment to establish the relationships between the glass durability and its composition.

We needed to establish the possible relationship between the composition and its performance in fiber Bragg devices in 85° C./85% relative humidity damp heat tests. Exposure of currently used SZP frit blends to damp heat conditions causes a change in appearance within a few days of exposure marked by a color shift from the initial deep blue to whitish-blue. To develop a better empirical understanding, a few fiber Bragg devices were made with three compositions. Table 9 illustrates center wavelength shifts for three frit Blends A, B, C, that have been prepared from Examples 6, 8, and 5, respectively, and a filler. There is no significant difference in the durability of these three compositions except that they have different amounts of boron. The center wavelength shifts, however, are markedly different for these compositions, and appear to correlate with the boron level. Compositions that have lower levels of B₂O₃ (1-2%) appeared to have negative center wavelength shifts, indicating slippage at the frit-fiber interface and suggesting that boron may have a key role in the frit-fiber bond.

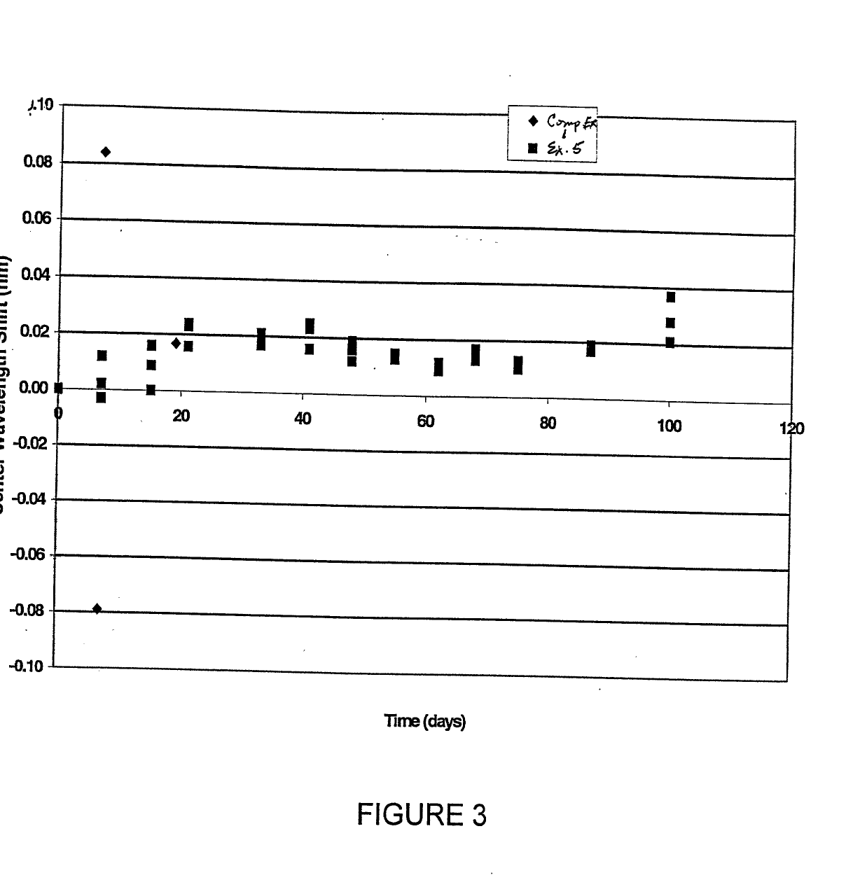

The effect of a more moisture durable SZP attachment frit on gratings performance may be seen in FIG. 3. Shown is center wavelength shift for gratings made with attachment frit based on existing SZP glass composition, Comparative Example 1, and Example 5 of the inventive glass frit compositions. Center wavelength stability measurements were made following storage of the grating in damp heat (85° C./85% relative humidity) chambers for the indicated time periods, in days. Note that the gratings attached with the existing standard SZP frit blend shifts to outside of the parameters of favored specification allowable drift, to ±0.08 nm, within 5 to 10 days of damp heat exposure. Current or evolving gratings have specifications that require narrower tolerances for center wavelength stability. The specification parameter for most grating applications is that center wavelength shift should not exceed ±0.05 nm. The inventive frit composition (Example 5) deviates much less than the standard frit (Comparative Example 1). In fact center wavelength drift remained within specification parameters even after 100 days of exposure.

As an industrial material, the desired properties of the inventive sealing glass frit as deployed in a fiber Bragg grating must be reproducible. To check reproducibility, we made another set of samples. The substrates were similar to those used in the prior experiment. The results were consistent with the boron hypothesis.

Residual stresses arise when the thermal expansion between the fiber, frit, and substrate are mismatched. The inventive phosphate glass compositions have a coefficient of thermal expansion (CTE) of about 90-110×10⁻⁷/°C. for samples that are made without fillers. To make the inventive glass compositions suitable for sealing a variety of low or negative expansion substrates, in practical application, the glass frits require incorporating fillers to minimize residual stresses that may arise. When a filler is used, the CTE of the inventive sealing frits can be reduced to zero or negative expansion. More particularly, frits have a CTE of approximately −10×10⁻⁷/°C. to 10×10⁻⁷/°C. when a filler is added.

Fillers, such as ([Co, Mg]₂P₂O₇), undergo a volume increase during cooling because of a phase transformation. By adjusting the ratio of Co/Mg, the temperature at which the filler transforms can be controlled. It is thus possible to minimize transient stresses during cooling by varying the volume fraction and composition of the fillers. To simulate a stress situation similar to that found in a fiber Bragg device, an asymmetric sandwich seal was used for measuring the transient stresses. The frit paste was stenciled onto a P-eucryptate substrate and a fused silica bar of approximately the same size as the substrate was placed on top. The sample was fired to about 500° C. We measured the stresses during cooling.

Experimental results indicated that a composition of frit could accommodate about half the mismatch strain between the β-eucryptite substrate and silica. Stresses start building during cool down at 325° C. and when the sample reaches 200° C., the silica bar develops cracks even before the inversion of the filler. To demonstrate the effect of fillers, another sample with fillers was examined. A mixed-filler specimen exhibited similar behavior to a single filler specimen, except that the sample assembly could be cooled to room temperature without failure of the silica bar. Photo-elastic stress measurements seem to suggest that compositions with mixed fillers are better in minimizing the transient stresses.

Although the present invention has been fully described by way of examples, it will be apparent to those skilled in the art that various modifications and variations can be made to the present glass compositions without departing from the spirit and scope of the invention. Therefore, unless such changes and modifications otherwise depart from the scope of the present invention, they should be construed as included herein.

We claim:

1. A lead-free sub-pyrophosphate SnO—ZnO—P₂O₅ glass composition, calculated in mole percent on an oxide basis, consisting essentially of: 24.5 to 29.0 % P₂O₅; 1.2 to 5.0 % B₂O₃; 1.0 to 2.0 % Al₂O₃; 0.0 to 2.0 % SiO₂; and sufficient amounts of SnO and ZnO, wherein the molar ratio of SnO:ZnO is in the range of about 5.0:1 to 12:1, and wherein the glass composition exhibits, under NMR spectroscopic analysis of ¹¹B nuclei, a signal containing at least two peaks at a chemical shift in the range of approximately −18 to −25 ppm.

2. The sub-pyrophosphate glass composition according to claim 1, wherein the glass frit exhibits long term stability, durability and resistance to attack by water under high temperature or humidity conditions.

3. The sub-pyrophosphate glass composition of claim 2, wherein the frit does not change in weight by more than 2-3 mg/cm² after 13 days of exposure to 90° C. aqueous conditions.

4. The sub-pyrophosphate glass composition according to claim 1, wherein the amount of SnO present is in the range of 51.5 to 66.5 mole %, and the amount of ZnO present is in the range of 5.0 to 12.0 %.

5. The sub-pyrophosphate glass composition according to claim 1, wherein the amount of P₂O₅ is in the range of 26.5 to 28.5 mole %.

6. The sub-pyrophosphate glass composition according to claim 1, wherein the amount of B₂O₃ is in the range of 1.0 to 2.8 mole %.

7. The sub-pyrophosphate glass composition according to claim 1, wherein the glass composition exhibits a signal containing at least two peaks at approximately −20 and −23 ppm.

8. The sub-pyrophosphate glass composition according to claim 1, wherein the glass composition has a coefficient of thermal expansion of 90-110×10⁻⁷/°C., and a coefficient of thermal expansion of −10×10−7/°C. to 10×10−7/°C. when a filler is added.

9. The sub-pyrophosphate glass composition according to claim 1, wherein the glass composition has a coefficient of thermal expansion of 90-110×10⁻⁷/°C., and a coefficient of thermal expansion of −10×10−7/°C. to 10×10−7/°C. when a filler is added.

10. A sealing material containing a lead-free sub-pyrophosphate SnO—ZnO—P₂O₅ glass frit, the composition of the glass as calculated on mole percent on an oxide basis, consists essentially of: 25.0 to 28.4 % P₂O₅; 1 to 5 % B₂O₃; 1 to 2 % Al₂O₃; 0.0 to 1.0 % SiO₂; and sufficient amounts of SnO and ZnO, wherein the molar ratio of SnO:ZnO ranges from about 5.0:1 to 12:1.

11. The sealing material according to claim 10, wherein the amount of SnO present in glass composition is in the range of 51.5 to 66.5 mole %, and the amount of ZnO present is in the range of 5.0 to 12.0%.

12. The sealing material according to claim 10, wherein the amount of P₂O₅ in the glass composition is in the range of 26.5 to 28.5 mole %.

13. The sealing material according to claim 10, wherein the amount of B₂O₃ in glass composition is in the range of 1.0 to 2.8 mole %.

14. The sealing material according to claim 10, wherein the glass composition exhibits, under NMR spectroscopic analysis of ¹¹B nuclei, a signal containing at least two peaks at a chemical shift in the range of approximately −18 to −25 ppm.

15. The sealing material according to claim 14, wherein the glass composition exhibits a signal containing at least two peaks at approximately −20 and −23 ppm.

16. An optoelectronic device having a sealing material that joins component parts, the sealing material comprising a glass frit having a composition, calculated in mole percent on an oxide basis, consisting essentially of: 24.5 to 28.5 % P₂O₅; 2.0 to 5.0% B₂O₃; 1.0 to 2.0 % Al₂O₃; 0.0-2.0 % SiO₂; and sufficient amounts of SnO and ZnO, wherein the molar ratio of SnO:ZnO is in the range of 5:1 to 12:1.

17. The optoelectronic device of claim 16, wherein the sealing material attaches an optical fiber to a substrate.

18. The optoelectronic device of claim 16, wherein said device is a fiber Bragg grating.

19. The optoelectronic device of claim 18, wherein said device has a center wavelength that does not vary more than ±0.05 nm.

20. The optoelectronic device of claim 16, wherein said device is a fiber coupler.

21. A method of attaching an optical fiber to a substrate by a sealing material comprising: a) providing at least one optical fiber and a substrate; b) using a sealing material comprising a lead free sub-pyrophosphate frit having a composition, as calculated in mole percent on an oxide basis, consisting essentially of 25.0 to 29.0% P₂O₅, 1.1 to 5.0 % B₂O₅, 1.0 to 2.0 % Al₂O₃, with SnO and ZnO in amounts such that the molar ratio of SnO: ZnO is in the range from 5:1 to 12: 1, (approximately 51.5 to 66.5 % SnO, 5.0 to 12.0 % ZnO), and 0.0 to 2.0 % SiO₂, to attach the fiber to the substrate; c) heating the sealing material to form a bond between the substrate, frit, and optical fiber, thereby attaching the optical fiber to the substrate.

22. The method according to claim 21, wherein the glass composition is capable of attaching a fiber Bragg grating without the need for a protective, hermetic chamber.
